(19) United States
(12) Patent Application Publication
(10) Pub. No.: US 2005/0203770 A1
(43) Pub. Date: Sep. 15, 2005

(54) Medical care experience

(75) Inventor: Maaike Wegman, Tilburg (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/518,837

(22) PCT Filed: Jun. 12, 2003
(86) PCT No.: PCT/IB03/02734

§ 371 Date: Dec. 21, 2004

(30) Foreign Application Priority Data
Jun. 27, 2002 (EP) 02077585.4

(51) Int. Cl. G06F 17/60

(52) U.S. Cl. 705/2

(57) ABSTRACT

The invention relates to a method enabling a person to obtain information on medical care equipment (A), the method comprising a step of offering the option to indicate the medical care equipment (A) on a user interface (1), comprising a step of transmitting, on receipt of the indication of the medical care equipment (A), information (B) related to the indicated medical care equipment (A) to the user interface, and comprising a step of offering the person an option to select a viewpoint, a further step of selecting from a database (3a), comprising three-dimensional representations of medical care equipment, a three-dimensional representation (R) of the indicated medical care equipment (A), and a step of generating a two-dimensional view (V) from a selected viewpoint of the selected three-dimensional representation (R). The person can personally control the viewpoint from which he or she wishes the two-dimensional view to be generated, and can thus experience the medical care equipment, which he or she will later experience as a patient, from different angles and views as a spectator in real life.

The invention relates to a method enabling a person to obtain information on medical care equipment, the method comprising a first step of offering the person an option to indicate a selected medical care equipment on a user interface, and a second step of transmitting, on receipt of an indication of the selected medical care equipment, information relating to the indicated medical care equipment to the user interface.

The invention also relates to a system enabling a person to obtain information on medical care equipment, comprising a user interface comprising means for indicating a selected medical care equipment on the user interface, and a computer means for receiving an indication of the selected medical care equipment from the user interface, and for transmitting, on receipt of said indication, information relating to the indicated medical care equipment to the user interface.

A person having the prospect of undergoing some kind of medical care activity often has poor access to understandable information on what to expect from this medical care activity and the medical care equipment used therewith. Often someone has some reservations about asking his or her specialist directly for information, and if he or she does, it is likely that the answer will be given in professional terminology which the person, being a layman or laywoman, does not understand very well. Another option to obtain the information is by looking it up on the Internet. Certain Internetsites offer the option to indicate certain medical care equipment in a search engine, which then offers access to known Internetsites comprising information on the medical care equipment. However, information on medical care equipment specifically meant for patients is hard to find among all the professional information, and even if it is found, it also suffers from the drawback of the complex terminology used.

It is an object of the invention to provide a method enabling a person to obtain information on medical care equipment in a user-friendly way.

To achieve this object, a method enabling a person to obtain information on a medical care equipment according to the invention is characterized in that the method comprises a step of offering generation of a two-dimensional view, from a viewpoint which is user-controllable, of a three-dimensional representation of the medical care equipment which is comprised in a database. A three-dimensional representation of the medical care equipment is comprised in a database, and a two-dimensional view of this three-dimensional representation is generated from a viewpoint which is chosen by the person. The person can personally control the viewpoint from which he wishes the two-dimensional view to be generated, and can thus experience the medical care equipment which he or she later will experience as a patient, that is, from different angles and views as a spectator in real life. A person due to undergo a medical care activity within the future, such as an examination, is thus offered the possibility to experience the medical care equipment used therewith in a user-friendly manner which is close to a real life experience. The fact that the person himself or herself is in control and is allowed to become familiar with all aspects of the medical care equipment at his or her own speed, offers a comfortable feeling with regard to the medical care equipment which may reflect to the appreciation of the hospital as a whole.

An embodiment of a method according to the invention is characterized in that the method comprises a step of offering an option to adjust the selected three-dimensional representation, representing a change in the configuration of the selected medical care equipment. In this manner the user is enabled to influence the characteristics of the three-dimensional representation in the database. This makes it possible to have a first two-dimensional view generated, which shows medical care equipment in a first position, then to execute a certain operation, which changes the properties of the three-dimensional representation in the database, and then to have generated a further two-dimensional view which shows the medical care equipment in a different position. The user may, for example, be enabled to move a movable part of the medical care equipment, or to move a handle or push buttons on it.

An embodiment of a method according to the invention is characterized in that the method comprises a step of offering an option to generate a sequence of two-dimensional views. In this manner the user is offered the possibility to experience a sequence of views which may, for example, offer an overview of the use of certain medical care equipment during a certain medical care activity.

An embodiment of a method according to the invention is characterized in that the information comprises audible information relating to the indicated medical care equipment. In this manner the experience of the two-dimensional visual information on the medical care equipment is enhanced by sound information.

It is advantageous when the medical care equipment comprises a medical examination device. In a real life situation the confrontation of the patient with the medical examination device is usually somewhat tense and uncomfortable, since a medical examination has to be undergone, in which the patient is a layman and all others present in the room are experts. When the medical care equipment offered on the user interface comprises a medical examination device, the person can experience the medical examination device, in any preferred manner and at a comfortable speed, when he or she is not yet in the situation of being a patient, that is, by controlling the generation of two-dimensional views of its three-dimensional representation, and by controlling its three-dimensional representation. The user may thus experience the medical examination device, for example, by watching the device from different angles as to obtain a view of all ins and outs of the device, or handling the user interface of the device so as to experience the device from the point of view of its operator.

It is especially advantageous when a viewpoint may be selected from which a two-dimensional view of an inside area of a medical examination device is generated. In certain medical examinations, such as Magnetic Resonance Imaging (MRI), the patient has to lie in an enclosed space for some time for the purpose of the examination. Often the idea of being enclosed in combination with not knowing what is happening outside the device causes patient anxiety in advance already. This has a negative effect on the actual experience, which leaves the patient in discomfort after the examination. However, when one is allowed to take a look at the inside of the MRI-device, and to see what happens at the outside of the device when the patient is lying within the device, the feeling of discomfort will be diminished.

It is advantageous when the audible information comprises an operating sound of the indicated medical examination device. In this manner the person is not only enabled to visually experience the device, but also to become familiar with the sounds it produces during operation. An explanation in spoken text can furthermore be given on which sounds relate to which actions of the device.

An embodiment of a method according to the invention is characterized in that the first step is combined with offering the person the option to include information on facial characteristics of himself or herself with this indication, which information is included in the selected three-dimensional representation. The information on facial characteristics can be incorporated into the two-dimensional views in such a manner that the user can view, as an external spectator, himself or herself on the user interface as a patient undergoing medical care activities with the medical care equipment.

It is advantageous when the first step is combined with offering the person the option to include the name of a medical care location, which indication is used for the selection of a three-dimensional representation of the indicated medical care equipment. In this manner the person is enabled to take a look at how a specific medical care location, such as a hospital in his neighbourhood, has set up the medical care equipment and processes related to it. This is advantageous for persons having the opportunity to make a choice themselves for a certain hospital, since they are enabled to compare the medical care equipment of various medical care locations. When one does not have this choice and is bound to a certain location for undergoing medical care activities, offering the person the option to indicate a medical care location is also advantageous for becoming familiar with the medical care equipment at said specific location.

A system enabling a person to obtain information on medical care equipment according to the invention is characterized in that it comprises means for selecting a viewpoint, a database comprising three-dimensional representations of medical care equipment, means for selecting from said database a three-dimensional representation based on the indication of the selected medical care equipment, and means for generating a two-dimensional view from a selected viewpoint of the selected three-dimensional representation.

The invention will be described in more detail hereinafter with reference to the drawings, in which

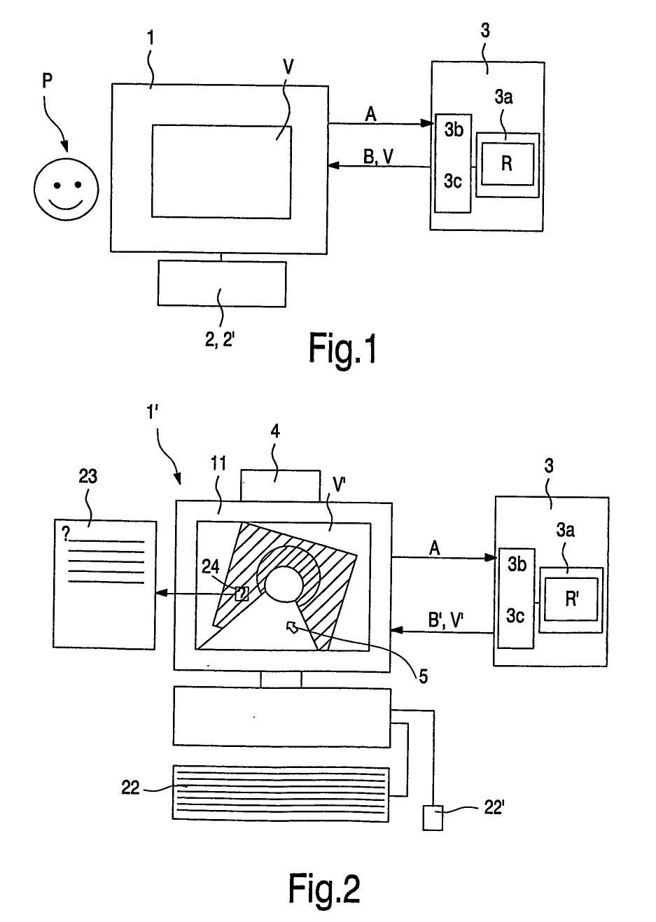

FIG. 1 shows a first embodiment of a system arranged to perform a method according to the invention enabling a person to obtain information on medical care equipment; and

FIG. 2 shows a detail of a further embodiment of a system arranged to perform a method according to the invention enabling a person to obtain information on medical care equipment.

FIG. 1 shows a first embodiment of a system arranged to perform a method enabling a person P to obtain information on medical care equipment. The system according to the invention comprises a user interface 1 with means 2 for indicating medical care equipment A on the user interface 1. Said means 2 comprise, for example, a keyboard for typing in the data, a computer mouse or touch screen for choosing from a list of medical care equipment, or means for voice input. It is to be noted that any type of generally known means for providing input to a user interface may be used.

The system also comprises a computer means 3 for receiving an indication of the selected medical care equipment A from the user interface 1 and for transmitting, on receipt of said indication, information B, V relating to the indicated medical care equipment A to the user interface. The computer means 3 comprises a database 3a which comprises a collection of three-dimensional representations R of medical care equipment A and means 3b for selecting from said database a three-dimensional representation R based on the indication of the selected medical care equipment A. Furthermore, the system comprises means 3c to generate, based on the selected viewpoint, a two-dimensional view V of a three-dimensional representation R of the medical care equipment A. The user can choose the viewpoint from which a two-dimensional view V of the medical care equipment A is generated, and can in this manner choose from which distance and from which angle he wishes to take a look at the medical care equipment A via the generated two-dimensional view V. The technical realization of offering a user-controllable viewpoint and the generation of a two-dimensional view from said viewpoint of a three-dimensional representation which is comprised in a database is known to persons skilled in the art and will, therefore, not be further elucidated herein.

In this embodiment such user control takes place through the means 2′ which also fulfil the function of enabling the person to indicate medical care equipment A on the user interface, such as, for example, the keys of a keyboard. It is to be noted that these means 2 and 2′ may also comprise separate devices, such as a keyboard 22 for typing in the data concerning the medical care equipment, and a mouse 22′ for controlling the generation of the two-dimensional view on the user interface. It is also to be noted that any type of generally known control and input means may be used.

In this embodiment, the information B comprises audible information B′ relating to the indicated medical care activity A. This audible information may comprise, for example, a voice describing certain elements of the medical care equipment, or sounds which originate during use of the medical care equipment, and which can be heard by the patient during this use.

The method according to the invention will be further elucidated on the basis of FIG. 2, relating to a situation in which a person has to undergo a medical care activity in a hospital and wishes to obtain more information on the medical care equipment involved. The person receives information from his doctor that he or she has to undergo a medical care activity in a hospital, in this case being a Magnetic Resonance Imaging (MRI) examination. The person, further indicated as the user, enters the term ‘MRI’ as the indication of medical care equipment A, via a keyboard 22, as input on the user interface 1′, which in this embodiment comprises a personal computer 11 provided with a monitor. The computer means 3 for receiving data from the user interface in the computer 11, which may be of the type of a generally known external server or the like, receive this data from the personal computer 11. The computer means 3 comprises in the collection of its database 3a a three-dimensional representation R′ of an MRI examination device and generates, based on input from the user, a two-dimensional view V′ 1 of the three-dimensional representation R′ of this device. The means 3 may comprise any known type of computer means able to perform these tasks, and will not be further elucidated herein.

In this embodiment the input for the generation of the two-dimensional view V′ of a three-dimensional representation R′ of the MRI-device on the user interface 1 is given by the user by means of a mouse 22′. By moving the mouse 22′, and hence a cursor 5 present on the monitor of the personal computer 11, two-dimensional views V′ of the three-dimensional representation R′ of the MRI-device are generated from different viewpoints, enabling the user to view the device on the user interface from various angles and distances and to virtually walk around it. In this manner, he or she can become familiar with the appearance of the device.

In this embodiment, the method comprises a step of offering an option to adjust the selected three-dimensional representation R′, representing a change in the configuration of the selected medical care equipment. The user can have a first two-dimensional view V′ generated, which shows medical care equipment in a first position, then execute a certain operation, which changes the properties of the three-dimensional representation R′ in the database, and then have a further two-dimensional view V′ generated which shows the medical care equipment A in a different position. The user may, for example, be enabled to move the table of the MRI-device, on which a patient rests during examination, into and out of the device by clicking on said table as displayed on the monitor with the cursor 5 driven by the mouse 22′ and dragging it to a different position. The user may, for example, also be enabled to activate buttons on the operator side of the device by clicking on them with the cursor 5 driven by the mouse 22′. In this manner the user is enabled to virtually interact with the medical care equipment A, next to controlling the viewpoint from which a two-dimensional view V′ is generated.

Furthermore, the systems offers the option to generate a sequence of two-dimensional views V′. The user is offered the possibility to experience a sequence of views which may, for example, offer an overview of the use of the medical care equipment during a certain medical care activity. In this embodiment, the user may activate the generation of a sequence of two-dimensional views V′ of the MRI-device during an MRI examination of a patient. The three-dimensional representation R′ of the MRI-device in this embodiment comprises all aspects of the device which it has during use. In this manner the user can experience the whole course of a MRI examination from beginning to end as a spectator, and become more familiar with all aspects of this examination, before experiencing it oneself as a patient. The sequence of views may be generated actively, that is, the generation of two-dimensional views V′ of the three-dimensional representation R′ of the MRI-device depends on the input the user gives during operation, via movement of the mouse 22′ and hence movement of the cursor 5 on the monitor. In this manner the user influences the viewing angle and distance from which he or she views the process of the examination with the MRI-device. The sequence of views may also be generated in a more passive manner, that is, the user controls the generation of a certain first two-dimensional view V′, for example, by clicking via the mouse 22′ on a start button on the user interface, and then activates a predetermined and stored sequence of two-dimensional views showing the MRI-device during use. In this manner the user can view the process of the examination with the MRI-device from a predetermined viewing angle and distance, that is, as a film.

Furthermore, in this embodiment a viewpoint may be selected from which a two-dimensional view of an inside area of a medical examination device, here the MRI-device, is generated. Via movement of the mouse 22′ and hence movement of the cursor 5 on the user interface 1, towards the entrance opening of the device, the user is thus offered the option to virtually enter the MRI-device, to experience the device from the inside in the same way as he will be experiencing the device during the examination. The audio data B′ in this embodiment comprises sounds which are related to the operation of the MRI device to provide the user an overall experience of everything he or she will see and hear during the examination with the MRI-device.

Furthermore, the user is offered the option to include information on facial characteristics of himself or herself with this indication, which information is included in the selected three-dimensional representation R′. In this embodiment a camera 4 is provided on the user interface for this purpose. It is to be noted that any type of generally known means for providing information on facial characteristics into a user interface may be used, including, for example, a scanned image of a previously taken picture of the user. The user activates this camera 4 to take a picture of his or her face, which picture is then sent along, with the other information, to the computer means 3. The picture is incorporated into the two-dimensional view V′ so that the user can watch on the user interface 1 a person, provided with his or her own facial characteristics, undergoing the medical care activity with the indicated medical care equipment A. This external viewing of oneself as a patient enhances the feeling of familiarity with the medical care equipment.

In this embodiment the two-dimensional view V′ comprises a hyperlink 24 to further information on the medical examination device. By clicking with the mouse 22′ on a certain area 24 of the two-dimensional view V′ of the device, a further screen 23 is reached which offers additional information on the device. This information comprises, for example, technical information or information on the manufacturer of the device. Furthermore, the information may, for example, indicate which hospitals are equipped with the device of a specific manufacturer. This is advantageous in a situation where people are allowed to choose the hospital they wish to undergo medical care activities. When they have become familiar with a specific examination device via the method and system according to the invention, they can decide on a hospital which offers these devices for the examination.

The user is also offered the option to indicate the name of a medical care location together with the indication of a selected medical care equipment A, which name indication is used for the selection of a three-dimensional representation R′ of the indicated medical care equipment A. In this manner the person is enabled to take a look at how a specific medical care location, such as a hospital in his neighbourhood, has set up said specific medical equipment and related processes.

It is to be noted that the method and system according to the invention may provide an experience of various medical care equipment via the user interface. For example, next to MRI-examination devices, other types of examination may be experienced, such as X-ray, Computed Tomography and Ultrasound. Next to examinations, other types of medical care equipment may be experienced such as the equipment used with radiotherapy, rehabilitation training, or surgery. In the latter case, the three-dimensional representation comprises, for example, an operating room, the equipment provided in such a room, and medical staff performing surgery on a patient present in said room.

It is to be noted that the method and system according to the invention may also advantageously be used to inform medical professionals on medical equipment. Companies selling professional medical care equipment strongly focus their attention on their direct customers. These customers are medical professionals who take the decisions on which medical care equipment should be installed in their hospital. To cater to these customers in an optimal manner, they are regularly invited to visit information centers or reference sites, hospitals in the vicinity. These information centers and reference sites are equipped with the newest ranges of professional medical care equipment to give the customers a chance to experience the equipment in action. They can walk around the equipment and be informed on all of its features by a qualified sales staff. In addition to, or instead of, visiting these reference sites, medical professionals may also be offered an experience of the medical care equipment via the method according to the invention, and thus obtain a thorough insight of the equipment without having to visit a reference site.

It is also to be noted that the system may comprise a personal computer as described hereinbefore, which is located at the user's home, and communicates with a server via a public switching network such as, for example, the Internet. Of course the user interface may also be located at a different location such as, for example, at the office of a person's family doctor. During a visit to the doctor, one may experience the medical care equipment in the presence of the doctor. The system may also be of another type, such as a personal computer comprising a CD-ROM and suitable software, or a virtual reality system.

The method and the system according to the invention enable large numbers of people to obtain information in a user-friendly manner on various medical care equipment simultaneously, irrespective of their location or the time of day.

1. A method enabling a person to obtain information on medical care equipment, the method comprising a first step of offering the person an option to indicate a selected medical care equipment (A) on a user interface (1), and a second step of transmitting, on receipt of an indication of the selected medical care equipment (A), information (B) relating to the indicated medical care equipment (A) to the user interface (1), characterized in that the method comprises:
a step of offering the person an option to select a viewpoint;
a further step of selecting, from a database (3a) comprising three-dimensional representations of medical care equipment, a three-dimensional representation (R) of the indicated medical care equipment (A); and
a step of generating a two-dimensional view (V) from a selected viewpoint of the selected three-dimensional representation (R).

2. A method as claimed in claim 1, wherein the method comprises a step of offering an option to adjust the selected three-dimensional representation, representing a change in the configuration of the selected medical care equipment (A).

3. A method as claimed in claim 1, wherein the method comprises a step of offering an option to generate a sequence of two-dimensional views.

4. A method as claimed in claim 1, wherein the information (B) comprises audible information (B′) relating to the indicated medical care equipment (A).

5. A method as claimed in claim 1, wherein the medical care equipment (A) comprises a medical examination device.

6. A method as claimed in claim 1, wherein a viewpoint may be selected from which a two-dimensional view of an inside area of a medical examination device is generated.

7. A method as claimed in claim 4, wherein the audible information (B′) comprises operating sound of the indicated medical examination device.

8. A method as claimed in claim 1, wherein the first step is combined with offering the person the option to include information on facial characteristics of himself or herself with this indication, which information is included in the selected three-dimensional representation (R).

9. A method as claimed in claim 1, wherein the first step is combined with offering the person the option to include the name of a medical care location (C), which indication is used for the selection of a three-dimensional representation (R) of the indicated medical care equipment (A).

10. A system enabling a person to obtain information on medical care equipment, comprising:
a user interface (1) comprising means (2,22) for indicating a selected medical care equipment (A) on the user interface (1); and
a computer means (3) for receiving an indication of the selected medical care equipment (A) from the user interface (1), and for transmitting, on receipt of said indication, information (B) relating to the indicated medical care equipment (A) to the user interface (1), characterized in that the system comprises:
means (2′) for selecting a viewpoint;
a database (3a) comprising three-dimensional representations of medical care equipment;
means (3b) for selecting, from said database (3a), a three-dimensional representation (R) based on the indication of the selected medical care equipment (A);
means (3c) for generating a two-dimensional view (V) from a selected viewpoint of the selected three-dimensional representation (R).
